(19) United States
(12) Patent Application Publication
(10) Pub. No.: US 2011/0156873 A1
(43) Pub. Date: Jun. 30, 2011

(54) RFID SYSTEM HAVING MULTI-SUBSCRIPTION FUNCTION AND OPERATION METHOD THEREOF

(75) Inventors: Hyung Rim CHOI, Busan (KR); Byung Kwon PARK, Busan (KR); Han Soo PARK, Busan (KR); Gwang Hoon KWAK, Busan (KR)

(73) Assignee: Dong-A University Research Foundation for Industry-Academy Cooperation, Busan (KR)

(21) Appl. No.: 12/723,180

(22) Filed: Mar. 12, 2010

(30) Foreign Application Priority Data
Dec. 30, 2009 (KR) 10-2009-0133631

(51) Int. Cl. H04Q 5/22

(52) U.S. Cl. 340/10.1

(57) ABSTRACT

An RFID system having a multi-subscription function, an RFID tag and an operation method thereof are provided. The RFID tag includes an RFID tag antenna, a tag storage unit, a sensor and a tag controller. The RFID tag antenna communicates with the RFID reader or the user terminal. The tag storage unit stores receives and stores user information transmitted from users. The sensor collects information on an object or environment to which the RFID tag is attached under the control of the tag controller. The tag controller classifies and arranges sensor information collected by the sensor for the user information of each user to generate tag information and transmits the generated tag information to the user terminal corresponding to the user information

### BACKGROUND OF THE INVENTION

1. Field of the Invention

The present invention relates to RFID (Radio Frequency Identification), and more particularly, to an RFID system having a multi-subscription function for allowing a plurality of users to acquire and operate information based on a single RFID tag and a method of operating the RFID system.

2. Description of the Related Art

An RFID system identifies a tag in the form of a thin plate, which is attached to an object, in a contactless manner through a radio signal and processes information corresponding to the identified tag. The RFID system includes an RFID reader having reading and deciphering functions, an RFID tag including tag information, and a network. The RFID tag consists of a transponder chip formed of a semiconductor and an antenna. RFID tags are divided into a passive tag having no internal power supply, which receives energy from a radio signal of an RFID reader to operate and an active tag having a battery. Further, the RFID tags are classified into a chip tag using a silicon semiconductor chip and a no-chip tag having only LC devices or plastic/polymer devices. In addition, the RFID tags are divided into read-only type and read-write type according to their information recording methods. RFID systems in various frequency bands ranging from frequencies lower than 150 KHz to microwaves higher than 5 GHz are being commercially used, and development, operation and administration of standardization of these systems are under the control IEC JTC1/SC31/WG4, part of ISO (International Standardization Organization).

Among these RFID systems, 433 MHz active RFID system settled as ISO/IEC 18000-7 is used to administrate containers in harbors. The 433 MHz active RFID system is implemented in such a manner that active tags are attached to containers and an RFID reader broadcasts all the active tags or individually broadcast the active tags. That is, an active tag broadcasted by the RFID reader transmits identification information thereof to the RFID reader and the RFID reader recognizes the transmitted identification information.

To manage containers in harbors, appropriate signal values that meet demands of various managers should be provided to the respective managers. In a conventional RFID system, however, once an RFID tag is attached to a container, all RFID tag information can be transmitted to only a manager(server) designated by reader. That is, various managers cannot collect desired information and can use only simple information transmitted from RFID tags reader. Accordingly, an RFID system, an operating method thereof and an RFID tag suitable for environments having various management point elements, such as harbors, are required.

### SUMMARY OF THE INVENTION

The present invention provides an RFID system having a multi-subscription function, which is able to collect and transmit information that meets demands of various users and an operating method thereof,

According to an aspect of the present invention, there is provided an RFID system having a multi-subscription function, which includes at least one user terminal and at least one RFID tag. The user terminal generates user information corresponding to each user. The RFID tag communicates with the user terminal, stores user information of a plurality of users, collects and generates tag information corresponding to the stored user information, and transmits the tag information to the corresponding user terminals. The RFID system may further include an RFID reader that transmits the user information to the RFID tag or receives the tag information of the RFID tag and transmits the tag information to the user terminal.

According to another aspect of the present invention, there is provided an RFID tag including an RFID tag antenna, a tag storage unit, a sensor and a tag controller. The RFID tag antenna communicates with an RFID reader or a user terminal. The tag storage unit receives and stores user information transmitted from a plurality of users. The sensor collects information on an object or environment to which the RFID tag is attached under the control of the tag controller. The tag controller classifies and arranges sensor information collected by the sensor for the user information to generate tag information and transmits the generated tag information to the user terminal that has transmitted the user information.

According to another aspect of the present invention, there is provided an RFID operation method including the steps of generating a plurality of user information items through at least one user terminal, transmitting the plurality of user information items to an RFID tag, storing the plurality of user items in the RFID tag, and respectively generating tag information for the stored user information items and transmitting the generated tag information to user terminals corresponding to the plurality of user information items.

According to the present invention, a plurality of users can receive desired information at desired time through the RFID system of the present invention, and thus they can perform RFID tag based management more efficiently and smoothly.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration of an RFID system having a multi-subscription function according to an embodiment of the present invention;

FIG. 2 is a block diagram of an RFID tag shown in FIG. 1;

FIG. 3 is a block diagram of a tag controller shown in FIG. 2;

FIG. 4 is a flowchart for explaining operations of transmitting and receiving a subscription message and a correction message in a method of operating the RFID system having a multi-subscription function according to the present invention; and

FIG. 5 is a flowchart for explaining an operation of stopping subscription in the method of operating the RFID system having a multi-subscription function according to the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

An RFID system according to the present invention has a multi-subscription function. The RFID system according to the present invention allows a plurality of users to access a single RFID tag to register their personal information in the RFID tag, input time at which the users want to receive specific information and type of the specific information and receive requested information at the time. In addition, the RFID system supports correction of information stored in the RFID tag. Furthermore, the RFID system according to the present invention can allow a user to set a limitation value to receive a warning message when specific information is generated and change information and time set by the user even when the RFID tag is remotely located. In the RFID system according to the present invention, the RFID tag stores registration information of a plurality of users. Further, the RFID system allows the users to directly access the RFID tag to acquire desired information. The RFID system, the RFID tag and a method of operating the RFID system according to embodiments of the present invention will now be explained with reference to the attached drawings.

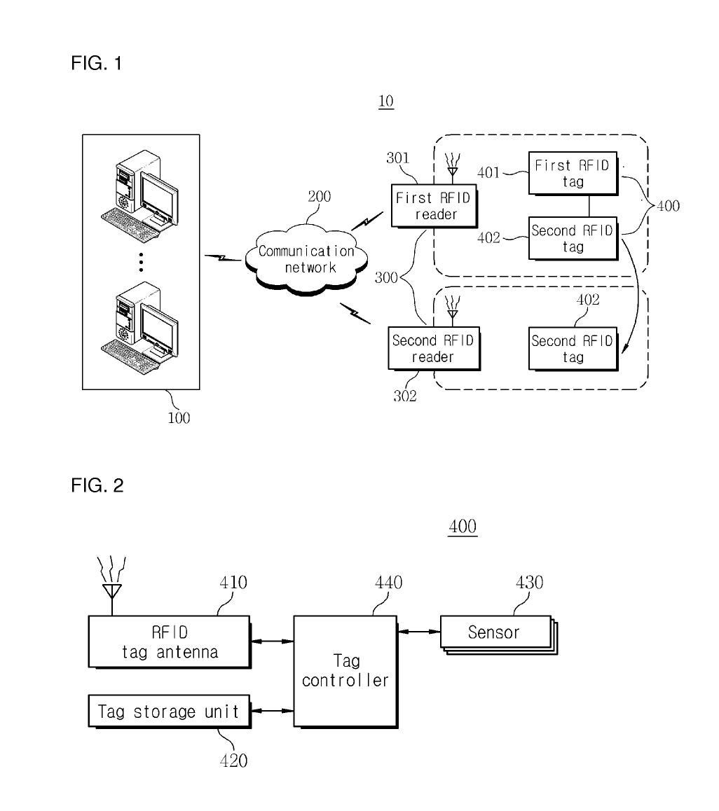

FIG. 1 illustrates a configuration of an RFID system 10 having a multi-subscription function according to an embodiment of the present invention.

Referring to FIG. 1, the RFID system 10 may include at least one user terminal 100, a communication network 200, RFID readers 300 having a first RFID reader 301 and a second RFID reader 302, and RFID tags 400 having a first RFID tag 401 and a second RFID tag 402. While the RFID system 10 includes the two RFID readers 300 and the two RFID tags 400 in the current embodiment of the invention, the present invention is not limited thereto. That is, the RFID system 10 of the present invention may include a plurality of RFID readers and a plurality of RFID tags or a single RFID reader and a single RFID tag. Furthermore, the RFID tag 400 can function as the RFID tag 300 when the RFID system 10 supports IP based communication, and thus the user terminal 100 can directly access the RFID tag 300 without passing through the RFID reader 300. In this case, the RFID reader 300 can be omitted.

The following description is given under the assumption that a plurality of users generate user information using a single user terminal 100 and transmit the user information to the RFID tag 400.

The RFID system 100 having the aforementioned configuration allows at least one user using at least one user terminal 100 to access the RFID reader 300 through the communication network 200 and control the RFID reader 300 to input user information to the RFID tag 400 located in the home network of the RFID reader 300. The RFID tag 400 may collect data based on the user information input by the at least one user and transmit the collected data to the corresponding user terminal 100 through the RFID reader 300. The following description is given under the assumption that the RFID reader 300 linked to the communication network 200 includes the first RFID reader 301 covering a home network and the second RFID reader 302 covering a foreign network, the first RFID tag 401 is located in the home network and the second RFID tag 402 moved from the home network is located in the foreign network. In this environment, a user who wants to obtain information on movement or state of a specific object based on the RFID tag 400 may operate the user terminal 100 to input user information of the user to the RFID tag 400. To achieve this, it is required that the RFID reader 300 and the RFID tag 400 are located in a communication available distance and the RFID reader 300 is connected to the user terminal 100 via the communication network 200. In this state, a plurality of users can communicate with the RIFD tag 400 through a specific RFID reader 300 using at least one user terminal 100. Here, the first RFID tag 401 and the second RFID tag 402 make subscription with the user terminals 100 when located in the home network of the first RFID reader 301. When the second RFID tag 402 is moved to the foreign network, the second RFID tag 402 informs the user terminals 100 having subscription with the first and second RFID tags 401 and 402 that the second RFID tag 402 is moved to the foreign network. If a user terminal 100 additionally sets a timer function when the subscription is made, the corresponding user terminal 100 is notified that communication is available in intervals set to a timer. If a user registers the timer function and a sensor function using a user terminal 100, the user terminal 100 informs the user of sensor information of a corresponding sensor in intervals set to the timer. Here, users can set different sensor information requests and different limitation values for the sensor information requests. The RFID tag 400 transmits sensor information to the corresponding user in intervals set by the user through the timer if the timer function, the sensor function and a limitation value with respect to specific sensor information are set. Further, the RFID tag 400 transmits tag information including a warning message to the user according to configuration if the specific sensor information exceeds or does not reach the limitation. The components of the RFID system 10 will now be explained in more detail.

The user terminal 100 is linked to the RFID reader 300 via the communication network 200 and controls the RFID reader 300 to transmit user information including at least one specific subscription message to the RFID tag 400. The user terminal 100 may be one of various computing devices. That is, the user terminal 100 may be a terminal capable of accessing the RFID reader 300 through the communication network 200, such as a notebook computer, PDA, portable multimedia player (PMP), PC or the like, which can be linked with the communication network 200. The user terminal 100 may includes a terminal communication unit capable of communicating with the communication network 200, a terminal input unit, a terminal storage unit, a terminal display unit, an audio processor and a terminal controller. The terminal communication unit may form a communication channel with the communication network 200, transmit a specific message, for example, user information, to the RFID reader 300 and receive tag information according to user input. The terminal input unit generates a message requested by a user and may be a keyboard, mouse, audio recognition unit or the like. The terminal storage unit may store information on the RFID reader 300 linked with the communication network 200. When information transmitted from the RFID tag 400 is received from the RFID reader 300, the terminal storage unit may temporarily store the information. The terminal display unit outputs various screens required to operate the user terminal 100. Specifically, the terminal display unit may output various menu screens for accessing the RFID tag 400 and information related to the RFID tag 400. When a specific user logs in the user terminal 100, the user terminal 100 may collect information of the RFID tag 400 to which the user is registered and output the information through the terminal display unit. Further, the user terminal 100 may provide a message generating screen by which the user sets information collection using the RFID tag 400. When the user terminal 100 receives tag information corresponding to a generated message from the RFID tag 400, the user terminal can output the received tag information. The user terminal 100 can output audio alarm using the audio processor when outputting the tag information. In summary, the user terminal 100 allows a plurality of users to access the RFID reader 300 through the communication network 200 according to configuration, collects information on the RFID tag 400 from the specific RFID reader 300 and outputs collected information to the users such that the users can confirm corresponding tag information. During these operations, the user terminal 100 can allow various users to access the specific RFID tag 400 and classify and store user information of the users when transmitting the user information to the specific RFID tag 400. When the user terminal 100 receives information from the RFID tag 400, the user terminal 100 can alarm a user who requests the received information such that the user can confirm the information. If a plurality of users access the communication network 200 using their computing devices, each computing device can be controlled to store user information transmitted from each user, judge information collected by the RFID reader 300 and output the collected information when it is determined that the collected information corresponds to the stored user information.

Here, the user information may include at least one of movement alarm setting information for setting alarm according to movement of the RFID tag 400, timer setting information for setting an information collecting interval, sensor setting information for setting the type of collected information, and limitation value setting information for setting a time at which information of a specific sensor is collected. Users can collect desired information in a desired form at a desired time using the specific RFID tag 400 by generating their user information. Moreover, the user terminal 100 can register the RIFID tag 400 operated by the user terminal 100, create user information for operating the RFID tag 400, transmit the user information and determine whether received tag information is output.

The communication network 200 is located between the user terminal 100 and the RFID reader 300 and transmits/receives data between the user terminal 100 and the RFID reader 300. The communication network 200 capable of generating a communication channel between the user terminal 100 and the RFID readers 300 may have various forms such as IP-based Internet, a communication network based on a specific address value, a network based on a cableless radio network, a network constructed based on a cable-based wired network and a mobile communication network supporting mobility. That is, the communication network 200 may be a network constructing at least one of a mobile communication network, WiBro (Wireless Broadband) network, HSDPA (High-Speed Downlink Packet Access) network, satellite communication network and wireless personal area network. Further, the communication network 200 may be a network employing Bluetooth, Zigbee, Rubee, IrDA (Infrared Data Association), UWB (Ultra Wide Broadband). The communication network 200 of the present invention is not limited to a communication network in a specific form and can use any network capable of transmitting and receiving messages between the RFID reader 300 and the user terminal 100.

The RFID reader 300 is linked to the user terminal 100 via the communication network 200 and has a specific home network. The RFID reader 300 is located at a point requested by a user and scans a communication available range according to the property of a device of the user. The RFID reader 300 may collect information on the RFID tag 400 existing in the home network thereof and transmit the collected information to the user terminal 100. Further, the RFID reader 300 transmits RFID tag setting information from the user terminal 100 to the RFID tag 400. When the RFID tag 400 is moved, the RFID reader 300 can transmit information on the movement of the RFID tag 400 to the specific user terminal 100. For example, when the first RFID tag 401 and the second RFID tag 402 are located in the home network of the first RFID reader 301, the first RFID reader 301 scans the first and second RFID tags 401 and 402 and informs the user terminal 100 that information of the first and second RFID tags 401 and 402 exist in the home network of the first RFID reader 301. Then, the user terminal 100 may determine that the first and second RFID tags 401 and 402 are located in the home network of the first RFID reader 301 and transmit user information generated for setting information of the first RFID tag 401 or the second RFID tag 402 to the first RFID reader 301. The first RFID reader 300 can transmit the user information to the first RFID tag 401 or the second RFID tag 402. In addition, the first RFID reader 301 may transmit tag information to the user terminal 100 through the communication network 200 when receiving the tag information from the first RFID tag 401 or the second RFID tag 402. In this operation, the first RFID reader 301 can transmit collected tag information to all the user terminals 100, and thus the user terminals 100 can confirm whether the tag information is information requested by them and receive the tag information based on the confirmation result. Furthermore, the first RFID reader 301 can transmit tag information of a specific RFID tag 400 to a specific user terminal 100 using an IP address allocated thereto when the first RFID reader 301 is based on IP information. When the second RFID tag 402 located in the home network of the first RFID reader 301 is moved to the foreign network of the second RFID reader 302, the second RFID reader 302 can scan the second RFID tag 402. Then, the second RFID reader 302 can collect information of the second RFID tag 402 and transmit the information to the user terminal 100. During this operation, the information of the second RFID reader 302 can be transmitted to all the registered user terminals 100 when the second RFID reader 302 is not based on an IP address or transmit only user terminals registered to the RFID tag 400 even if the second RFID reader 302 is not based on the IP address. The user terminal 100 can recognize the movement of the second RFID tag 402 to the foreign network of the second RFID reader 302 and output information according to the recognition when the user terminal 100 is registered to the second RFID tag 402.

The RFID tag 400 may transmit information previously stored according to scanning of the RFID reader 300 to the RFID reader 300 when the RFID tag 400 is located in the home network of the RFID reader 300 and store user information transmitted through the RFID reader 300 in a memory, collect and transmit tag information based on the user information. The RFID tag 400 may be attached to an object and moved with the object when the object is moved. When the RFID tag 400 is moved, the position of the RFID tag 400 may be tracked by the RFID reader 300 that scans the RFID tag 400. Tag information used by the RFID tag 400 may include a header field, tag data field and tag error check code field. The header field includes information that defines the length, structure and function of a tag. The tag data field includes a domain classification code field representing a tag type and service field, a tag ID field representing tag identification information, a user data field representing information on services additionally defined by a service provider and a tag owner, a reservation field additionally defined and used, and a password field for security. The error check code is used to confirm validity of received tag data. In the case of a tag attached to a product, for example, the user data field may store additional management data information such as information on the term of validity written on the product by the product manufacturer and position information defined by a product seller. Further, the tag ID field may store product manufacturer information and tag ID. The domain classification field may store inventory management information, service place information, regional branch office code information, manufacturer, application field information, cart classification, cart ID and ID flag. Particularly, tag information generated by the RFID tag 400 according to the present invention may include information for identifying a plurality of users and collected information requested by users. Accordingly, the RFID tag 400 of the present invention can collect tag information and transmit the collected information according to user information stored therein. That is, the RFID tag 400 of the present invention can store at least one of timer setting information, sensor setting information and limitation value setting information for each user information, store only user information for informing a corresponding user terminal of movement of the RFID tag 400 when the RFID tag 400 is moved, collect data based on the user information and transmit the collected data to the corresponding user terminal 100. The RFID tag 400 will now be explained in more detail with reference to FIG. 2.

FIG. 2 is a block diagram of the RFID tag 400 having a multi-subscription function according to an embodiment of the present invention, shown in FIG. 1.

Referring to FIG. 2, the RFID tag 400 may include an RFID tag antenna 410, a tag storage unit 420, at least one sensor 430 and a tag controller 440.

The RFID tag 400 having the aforementioned configuration may perform communication with the RFID reader 300 based on the RFID tag antenna 410 and store user information received through the communication in the tag storage unit 420. Further, the RFID tag 400 may operate the sensor 430 based on the user information stored in the tag storage unit 420 to collect sensor information or transmit the sensor information collected based on the user information while operating the sensor 430 to the RFID reader 300 through the RFID tag antenna 410. The tag controller 440 may determine a tag information transmitting interval using a timer. The components of the RFID tag 400 will now be explained in more detail.

The RFID tag antenna 410 receives data transmitted during the scanning operation of the RFID reader 300 and transmits tag information that is a response message corresponding to the data to the RFID reader 300. The RFID antenna 410 receives a message transmitted from the user terminal 100 through the RFID reader 300 and transmits the message to the tag controller 440. Further, the RFID tag antenna 410 may transmit information collected by the sensor 430 to the RFID reader 300 under the control of the tag controller 440. The RFID tag antenna 410 may take various forms such as a coil antenna and a pattern antenna.

The tag storage unit 420 stores user information of each user, transmitted from the RFID reader 300. Here, the user information may include at least one of movement alarm setting information, timer setting information, sensor setting information and limitation value setting information. The timer setting information sets an interval in which information collected by the sensor 430 is transmitted to the RFID reader 300. The sensor setting information designates a specific sensor among various sensors 430 included in the RFID tag 400. The limitation value setting information defines a time at which sensor information is transmitted to the user terminal 100 while a specific sensor collects the sensor information. The tag storage unit 420 may temporarily store the sensor information collected by the sensor 430.

The sensor 430 may mean various sensors which belong to the RFID tag 400 or are controlled by the tag controller 440. The sensor 430 may include sensors collecting information on an object to which the RFID tag 400 is attached and an environment in which the RFID tag 400 is located, such as a piezoelectric sensor, temperature sensor, humidity sensor, geomagnetic sensor, acceleration sensor, optical sensor, illumination sensor, etc. The sensor 430 may be activated under the control of the tag controller 440 and turned on periodically or all the time to perform a sensing operation. Sensor information collected by the sensor 430 is transmitted to the tag controller 440.

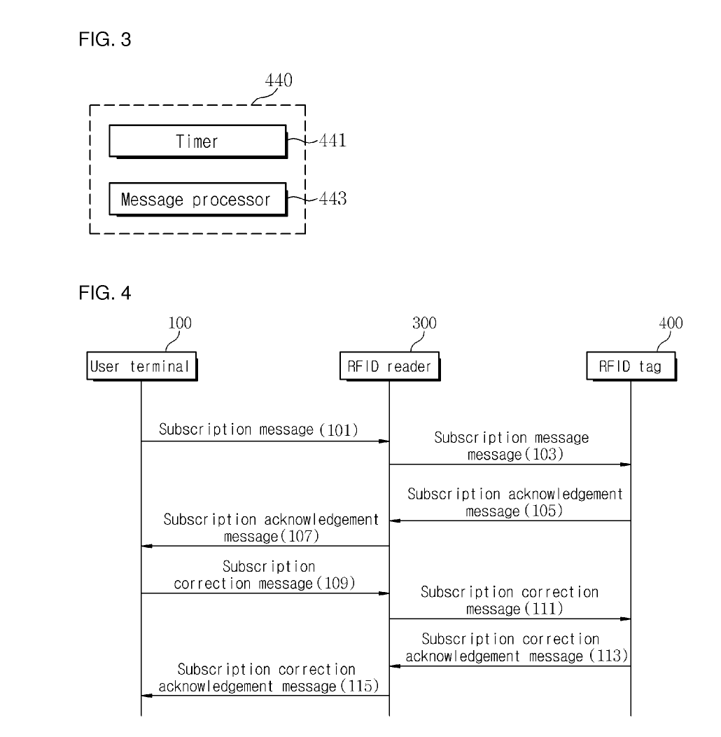

The tag controller 440 classifies sensor information collected by the sensor 430 based on the user information stored in the tag storage unit 420, generates tag information including the classified sensor information and transmits the tag information to the corresponding user terminal 100. Here, the tag controller 440 may transmit the tag information including the sensor information in predetermined intervals according to user information, classify the sensor information based on the contents of a message transmitted from user terminals 100 and generate tag information based on the classified sensor information. To achieve this, the tag controller 440 may include a timer 441 and a message processor 443, as shown in FIG. 3.

The timer 441 checks a predetermined interval for user information corresponding to each user, stored in the tag storage unit 420. The timer 441 may include a plurality of timers in order to satisfy a case in which a plurality of users want to receive tag information including sensor information at every time they want. The plurality of timers 441 may be respectively used for the plurality of users or the single timer 441 may be used for the plurality of users. When the single timer 441 is used, a count is increased by one in predetermined intervals, for example, every one second, one minute or ten minutes, the time set by each user is divided by the count, and information is transmitted to a user corresponding to a remainder 0. That is, the timer 441 is operated for user information corresponding to each user and transmits corresponding information to the tag controller 440 at a set timer end time. Here, the timer 441 may transmit information for recognizing user information together with timer end alarm to the tag controller 440. Then, the tag controller 440 can determine the user terminal 100 to which tag information will be transmitted when the timer is ended.

The message processor 443 may be controlled to transmit tag information to the specific user terminal 100 when the timer 441 is ended or in predetermined intervals when the timer 441 is not set. During this operation, the message processor 443 may be controlled to collect and classify sensor information based on set user information and generate tag information including the sensor information. Here, the message processor 443 may confirm user information, collect and classify sensor information to be transmitted to the specific unit terminal 100. Then, the message processor 443 may generate tag information including the classified sensor information and transmit the tag information to the user terminal 100 based on the user information when the timer 441 is ended.

As described above, the RFID system 10 of the present invention can allow a plurality of user to input user information to the single RFID tag 400. The RFID tag 400 can collect and generate tag information according to the input user information and transmit the generated tag information to the user terminal 100 corresponding to the input user information of each of the plurality of users.

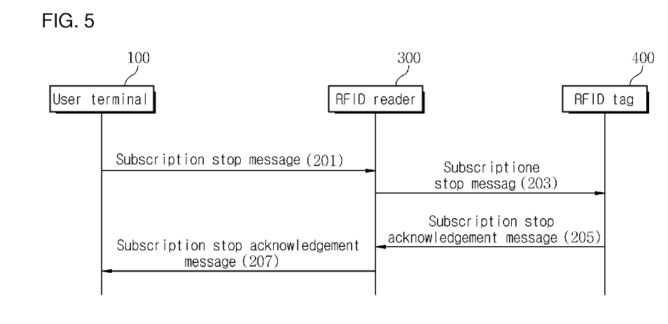

The configurations and functions of the RFID system 10 and the RFID tag 400 according to an embodiment of the present invention have been described. Transmission and receiving of messages in the components of the RFID system 10 will now be explained in more detail with reference to FIGS. 4 and 5.

FIG. 4 is a flowchart for explaining operations of transmitting and receiving a subscription message and a subscription correction message in a method of operating the RFID system having a multi-subscription function according to an embodiment of the present invention.

Referring to FIGS. 1 and 4, when the RFID tag 400 is located in the home network of the specific RFID reader 300, the user terminal 100 transmits a subscription message to the RFID reader 300 in operation 101. The RFID reader 300 transmits the received subscription message to the RFID tag 400 so as to request subscription in operation 103. When the RFID tag 400 substantially arrives at the home network of the specific RFID reader 300, the RFID reader 300 and the RFID tag 400 can communicate with each other to inform the RFID reader 300 that the RFID tag 400 is located in the home network of the RFID reader 300. Then, the RFID reader 300 can inform the user terminal 100 that the RFID tag 400 is located in the home network of the RFID reader 300. When the RFID tag 400 corresponds to the RFID tag of the user terminal 100, the user terminal 100 may create a predetermined subscription message according to user request or schedule information and transmit the subscription message to the RFID tag 400 through the RFID reader 300.

When the RFID tag 400 receives the subscription message from the RFID reader 300, the RFID tag 400 reads user information included in the received subscription message and stores the read user information in the tag storage unit (420 shown in FIG. 2). If subscription is normally made between the RFID tag 400 and the user terminal 100, the RFID tag 400 transmits a subscription acknowledgement message that represents the subscription has been successfully made to the RFID reader 300 in operation 105. The RFID reader 300 transmits the subscription acknowledgement message to the user terminal 100 in step 107.

A plurality of users may operate the user terminal 100 to collect sensor information using the RFID tag 400. To achieve this, users who acquire the authority to operate the RFID tag 400 may create a subscription correction message including user information that sets characteristics of tag information that the users want to acquire based on the RFID tag 400. The user terminal 100 can provide a user interface by which each user creates his/her user information. When each user creates the subscription correction message and requests the user terminal 100 to transmit the subscription correction message to the RFID tag 400, the user terminal 100 transmits the subscription correction message to the RFID reader 300 in operation 109. The RFID reader 300 receives the subscription correction message and delivers the subscription correction message to the RFID tag 400 in operation 111. The RFID tag 400 receives the subscription correction message, generates a subscription correction acknowledgement message corresponding to the subscription correction message, and transmits the subscription correction acknowledgement message to the RFID reader 300 in operation 113. Then, the RFID reader 300 may transmit the received subscription correction acknowledgement message to the user terminal 100 in operation 115.

Here, the subscription correction message may have various message forms. That is, the subscription correction message may include at least one of a subscription request message for performing subscription, a subscription time request message for requesting message transmission in predetermined intervals, a subscription sensing value request message for requesting specific sensor information, and a subscription limitation request message for setting limitation of a specific sensor. That is, the user terminal 100 can create the subscription correction message corresponding to one of the aforementioned messages or a combination of multiple messages, for example, a combination of the subscription time request message and the subscription sensing value request message, a combination of the subscription sensing value request message and the subscription limitation request message, or a combination of the subscription time request message, the subscription sensing value request message and the subscription limitation request message, and transmit the subscription correction message to the RFID tag 400.

Here, the messages can use a data format similar to the subscription message. The messages can be identified by different field types thereof. If the RFID tag 400 makes subscription with the user terminal 100 and receives a specific subscription correction message from the user terminal 100, the RFID tag 400 can update information stored in the tag storage unit 420 to the final received message corresponding to user information of the user terminal 100. In other words, the RFID tag 400 of the present invention can collect sensor information included in the user information in the interval set to the timer, generate tag information based on the collected sensor information, collect the sensor information included in the user information based on the limitation and generate tag information based on the collected sensor information. Furthermore, the RFID tag 400 of the present invention collects the sensor information included in the user information in the interval set to the timer. The RFID tag 400 may compare the sensor information with the limitation and generate tag information based on the comparison result. In addition, when the RFID tag 400 is moved from the home network of a specific RFID reader to a foreign network of another RFID reader, the RFID tag 400 can generate tag information for transmitting corresponding alarm to the user terminal. That is, when the RFID tag 400 is deviated from a limitation range set in an event form, the RFID tag 400 can inform users of the deviation.

The subscription request message informs the registered user terminals 100 the RFID tag 400 is moved from the home network to a foreign network whenever the RFID tag 400 is moved to foreign networks of other RIFD readers

The subscription time request message delivers contents that each user terminal 100 can communicate with the RFID tag 400 in a predetermined interval corresponding to time, set to the timer (441 shown in FIG. 3) according to user information transmitted from the user terminal 100, to the user terminal 100 and the user registered to the user terminal 100. If the subscription time request message is used together with the subscription sensing value request message, the RFID tag 400 may transmit requested sensor information instead of the message informing the corresponding user that communication is available to the corresponding user terminal 100.

The subscription sensing value request message may be used as two functions. Firstly, the subscription sensing value request message may be used to transmit sensor information included in user information to the corresponding user terminal 100 in a predetermined interval corresponding to time set by the user terminal 100 when subscription timer request is registered. Here, different sensor information items are requested for respective user information items. If the subscription timer request is not registered, the subscription sensing value request message may be used as a message that requests the current sensor information of the RFID tag 400 in the form of a command transmitted from the user terminal 100 to the RFID tag 400. That is, when the RFID tag 400 receives the subscription sensing value request message in a state in which there is no additional registration information, the RFID tag 400 confirms sensor information included in the corresponding user information and transmits sensor information requested by the corresponding user terminal 100 to the user terminal 100. Even in this case, different sensor information items are requested for respective user information items

The subscription limitation request message is a message setting a limitation of a specific sensor. When the specific sensor (430 shown in FIG. 2) is deviated from the set limitation, the subscription limitation request message is used to inform the user terminal 100 that the deviation of the sensor. The subscription limitation request message may be set for each sensor 430.

As described above, the RFID system 10 of the present invention allows each user to receive tag information including information on various sensors from the specific RFID tag 400 using the subscription correction message.

FIG. 5 is a flowchart for explaining an operation of ending subscription in the method of operating the RFID system having a multi-subscription function according to the present invention.

Referring to FIGS. 1 and 5, when the user terminal 100 transmits a subscription stop message to the RFID reader 300 in operation 201, the RFID reader 300 transmits the subscription stop message to the corresponding RFID tag 400 in operation 203. When the RFID tag 400 receives the subscription stop message, the RFID tag 400 may judge the type of the subscription stop message and stop an information collecting operation according to user information stored in the tag storage unit (420 shown in FIG. 2). If this operation is normally performed, the RFID tag 400 transmits a subscription stop acknowledgement message to the RFID reader 300 in operation 205. Then, the RFID reader 300 may transmit the received subscription stop acknowledgement message to the user terminal 100 in operation 207. If the RFID tag 400 receives a subscription all stop message, corresponding user information is deleted from the tag storage unit 420 of the RFID tag 400. The subscription stop message includes a subscription request stop message, a subscription time request stop message, a subscription sensing value stop message, a subscription limitation stop message and the subscription all stop message.

The subscription request stop message requests transmission of subscription message according to movement to be stopped. The subscription time request message is used to stop the cycle of the timer 441, set in user information, or stop use of the timer 441. The subscription sensing value stop message is used to stop or cancel collection of information of a specific sensor 430. The subscription limitation stop message is used to delete a limitation set to the specific sensor 430.

As described above, the RFID system, RFID tag and operating method thereof can allow a plurality of users to input contents of desired information and time at which the users want to acquire the desired information to the RFID tag 400 so as to obtain the desired information at the desired time. For example, if an RFID tag is set inside a container in order to monitor the inner state of the container and users (ship company, freight owner/forwarder, terminal) who want to monitor the inner state of the container register the type of information to be monitored and time when they want to monitor the information to the RFID tag, the RFID tag transmits corresponding information to the users at the time set by the users. Even when the container is moved, the RFID tag transmits the corresponding information to the users in intervals corresponding to the time set by the users. That is, the present invention can be efficiently applied to a system that accepts a plurality of users to acquire information on the same place.

Furthermore, a plurality of users can set limitations with respect to information of a specific sensor for a single RFID tag. Accordingly, when information collected by the RFID tag exceeds or does not reach the limitations, the users are informed of it, and thus it is possible to easily manage products according to the specific sensor.

Moreover, a plurality of users can input their information to a single RFID tag to acquire information on movement of the continuously moving RFID tag without performing an additional operation. In addition, the users can request and respond to information provided by the RFID tag through a specific command, and thus the number of unnecessary operations is reduced and the users can be ware of whether they can currently communicate with the RFID tag. In the RFID system, RFID tag and operating method thereof according to the present invention, transparency of information is guaranteed since a plurality of users receive information generated by a single RFID tag, and thus information fabrication cannot be performed and data reliability is secured. Further, since only users registered to the RFID tag can receive data generated by the RFID tag, security is reinforced.

The RFID system, operating method thereof and RFID tag of the present invention can classify users into classes and give priority to only a specific class to allow the specific class to use services provided by the RFID system.

If IP framework is introduced to the RFID system having the multi-subscription function, as described above, a plurality of users can directly access an RFID tag without using RFID readers to acquire or control information of the RFID tag. That is, the RFID tag having IP function serves as an RFID reader, and thus user terminals can directly communicate with the RFID tag without using an RFID reader.

While a plurality of users respectively generate user information including subscription using a plurality of user terminals and transmit the user information to a specific RFID tag in the aforementioned embodiments, the present invention is not limited thereto. In the RFID system of the present invention, a plurality of users can transmit their user information to a specific RFID tag and receive tag information corresponding to the user information using a single user terminal. Furthermore, a single user can generate a plurality of user information items, transmit the user information items to a specific RFID tag and receive tag information corresponding to the user information items using a single user terminal.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An RFID system having a multi-subscription function, comprising:
at least one user terminal; and
at least one RFID tag communicating with the at least one user terminal,
wherein the RFID tag stores user information of a plurality of users, collects and generates tag information corresponding to the stored user information, and transmits the generated tag information to the respective user.

2. The RFID system of claim 1, wherein the user information includes at least one of movement alarm setting information for requesting generation of the alarm about movement of the RFID tag, timer setting information for determining a tag information transmitting interval, sensor setting information for designating at least one sensor included in the RFID tag, and limitation setting information for setting a limitation of a specific sensor.

3. The RFID system of claim 2, wherein at least one of the movement alarm setting information, timer setting information, sensor setting information and limitation setting information is generated differently for the respective user information items.

4. The RFID system of claim 1, wherein the user terminal comprises:
a terminal input unit generating an input signal for generating the user information with respect to each user;
a terminal storage unit storing the user information with respect to each user;
a terminal communication unit transmitting the generated user information to the RFID tag; and
a terminal control unit controlling generation, storage and transmission of the user information and raising the alarm about receiving of tag information from the RFID tag.

5. The RFID system of claim 1, further comprising a communication network supporting information exchange between the user terminal and the RFID tag based on IP.

6. The RFID system of claim 5, wherein the RFID tag has a reader function and communicates with the user terminal.

7. The RFID system of claim 1, further comprising an RFID reader communicating with the RFID tag and the user terminal, scanning a predetermined home network and allowing the RFID tag and the user terminal to communicate with each other.

8. The RFID system of claim 7, wherein the RFID tag comprises:
an RFID tag antenna communicating with the RFID reader or the user terminal;
a tag storage unit storing the received user information;
a sensor collecting information on an object or environment to which the RFID tag is attached; and
a tag controller classifying and arranging sensor information collected by the sensor for the user information of each user to generate tag information and transmitting the generated tag information to the user terminal that has transmitted the user information.

9. The RFID system of claim 8, wherein the user terminal generates and transmits at least one of a subscription request message for performing subscription, a subscription time request message for requesting message transmission in predetermined intervals, a subscription sensing value request message for requesting specific sensor information, a subscription limitation request message for setting a limitation of a specific sensor, a subscription request stop message for stopping transmission of the subscription request message according to movement, a subscription time request stop message for stopping a timer cycle set to the user information, a subscription sensing value stop message for stopping collection of information of a specific sensor, a subscription limitation stop message for deleting a limitation set to a specific sensor, and a subscription all stop message for deleting corresponding user information stored in the RFID tag according to user input.

10. An RFID tag having a multi-subscription function, comprising:
an RFID tag antenna communicating with an RFID reader or a user terminal;
a tag storage unit storing user information of a plurality of users;
a sensor collecting information on an object or environment to which the RFID tag is attached; and
a tag controller classifying and arranging sensor information collected by the sensor for the respective user information items to generate tag information and transmitting the generated tag information to the user terminal that has transmitted the user information.

11. The RFID tag of claim 10, wherein the user information includes at least one of movement alarm setting information for requesting generation of the alarm about movement of the RFID tag, timer setting information for determining a tag information transmitting interval, sensor setting information for designating at least one sensor included in the RFID tag, and limitation setting information for setting a limitation of a specific sensor

12. The RFID tag of claim 11, wherein at least one of the movement alarm setting information, timer setting information, sensor setting information and limitation setting information is generated differently for the respective user information items.

13. The RFID tag of claim 11, wherein the tag controller generates at least one of tag information based on sensor information included in the user information, which is collected by the timer cycle, tag information based on sensor information included in the user information, which is collected based on the limitation, tag information generated based on a result obtained by comparing the sensor information included in the user information, which is collected by the timer cycle, with the limitation, and tag information for transmitting corresponding alarm to the user terminal when the RFID tag is moved from the home network of a specific RFID reader to a foreign network of another RFID reader.

14. The RFID tag of claim 11, wherein, when the tag controller receives a message for deleting at least one of the movement alarm setting information, timer setting information, sensor setting information, critical value setting information and specific user information including all the information, the tag controller controls information with respect to the corresponding message to be deleted from the tag storage unit.

15. An RFID operation method comprising the steps of:
generating a plurality of user information items through at least one user terminal;
transmitting the plurality of user information items to an RFID tag;
storing the plurality of user items in the RFID tag; and
respectively generating tag information for the stored user information items and transmitting the generated tag information to user terminals corresponding to the plurality of user information items.

16. The RFID operation method of claim 15, wherein the step of generating the user information comprises at least one of the steps of:
generating movement alarm setting information for requesting generation of the alarm about movement of the RFID tag;
generating timer setting information for determining a tag information transmitting interval;
generating sensor setting information for designating at least one sensor included in the RFID tag; and
generating limitation setting information for setting a limitation of a specific sensor.

17. The RFID operation method of claim 16, wherein the step of generating the user information generates at least one of the movement alarm setting information, timer setting information, sensor setting information and limitation setting information differently for the respective user information items.

18. The RFID operation method of claim 16, wherein the step of generating the user information comprises at least one of the steps of:
generating a message for stopping a request according to movement of the RFID tag;
generating a message for stopping the tag information transmitting interval;
generating a message for canceling designation of at least one sensor included in the RFID tag;
generating a message for canceling setting of a limitation of the specific sensor; and
generating a message for deleting at least one of the plurality of user information items.

19. The RFID operation method of claim 16, wherein the step of generating and transmitting the tag information comprises at least one of the steps of:
generating tag information based on sensor information included in the user information, which is collected by a timer cycle;
generating tag information based on sensor information included in the user information, which is collected based on the limitation;
generating tag information based on a result obtained by comparing the sensor information included in the user information, which is collected by the timer cycle, with the limitation; and
generating tag information for transmitting corresponding alarm to the user terminal when the RFID tag is moved from a home network of a specific RFID reader to a foreign network of another RFID reader.

20. The RFID operation method of claim 15, further comprising the step of dividing the user terminals into at least one class, wherein the step of generating the user information generates user information for each class.
